(19) United States
(12) Patent Application Publication
(10) Pub. No.: US 2026/0048971 A1
(43) Pub. Date: Feb. 19, 2026

(54) Lifting and Gripping Device

(71) Applicant: Thomas Marsh, SR., Jacksonville, FL (US)

(72) Inventor: Thomas Marsh, SR., Jacksonville, FL (US)

(21) Appl. No.: 18/807,322

(22) Filed: Aug. 16, 2024

(51) Int. Cl. B66F 9/18

(52) U.S. Cl. CPC B66F 9/186

(57) ABSTRACT

A lifting and gripping device including a solid, non-tubular construction, a beveled or wavy washer and rotating head to retard rotation under a design movement force, an automatic release safety lift latch to lock and unlock the gripping arms in the open and closed positions, two receiving slots for the forks of a fork lift, and a forklift safety chain to prevent the device from slipping off the forklift forks. The beveled or wavy washer of the rotating head is designed to prevent unnecessary rotation of the lifted object upon movement of said object by the forklift. The two receiving forklift fork receiving slots are designed to accommodate the forks of a forklift which upon lifting of the fork, actuates the lifting and gripping arms to close around the base of the object to be lifted. The safety latch is actuated by the forklift operator to initiate the gripping upon lifting. Once the lifted object is placed, the gripping arms open to release pressure on the object and simultaneously actuate the locking mechanism such that if the device is then lifted again, the gripping arms will not close unless and until the safety lock is re-engaged.

### BACKGROUND OF THE INVENTION

### Field of Invention

The technology described in the disclosed patent document relates generally to the field of lifting and gripping devices and the like for the movement of pavers, paver pallets, metal works, concrete blocks, CSU's, CMU's, etc.

### Discussion

Typical lifting devices employ tubular construction thereby leading to a structural weakness in the weight lifting capacity of the device itself before buckling occurs. Additionally, typical devices utilize a single actuating lift chain to cause the device to grip an object for lifting. This creates a chain breaking hazard along with additional safety hazards as the object being lifted and moved is free to swing about the chains axis making control difficult. Further still, typical devices do not directly interface with the forks of a forklift for the use and actuation of the lifting and gripping device.

One drawback to the above mentioned systems is the lack of a safety locking latch to assure the gripped object will not be released inadvertently through gripping failure. A second drawback of these types of devices is the lack of adjustable arms lengths to accommodate varying sized payloads. Therefore it is the object of this invention to solve one or more of these problems.

### Purpose of the Invention

The purpose of the disclosed invention is to provide a device for the gripping, lifting, and movement of pavers, paver pallets, metal works, concrete blocks, CSU's, CMU's, or the like.

### PRIOR ART

Lifting and gripping devices for the movement of various objects are well known. Existing devices are incapable of arresting rotation during movement and consistently present challenges and safety risks as such. Further, current devices are actuated through the use of a lift chain or a permanent attachment to the end of a lift arm that may or may not be hydraulically powered. Further, existing gripping and lifting devices use hollow metal tubes in their construction which generate a structural weight lifting limit or device use restriction. Thus, continued improvements in the exploitation of lifting and gripping devices incorporating increased structural strength and additional safety features are constantly being sought.

### SUMMARY OF THE INVENTION

In accordance with the teachings of this invention as embodied and described herein, systems are provided for a means to grip and lift a variety of materials including but not limited to pavers, paver pallets, metal structures, concrete block, CSU's, CMU's and the like, through the use of a lifting and gripping device incorporating increased structural device strength, a fork lift attachment with a rotation retarding mechanism, an automatic safety latch, and a safety chain. Said lifting and gripping device includes a solid, non-tubular construction, two receiving slots for the forks of a fork lift, a beveled or wavy washer and rotating head to reduce or retard unnecessary rotation under a design movement force when said object is lifted by a forklift, a forklift pressure actuated automatic safety latch to lock the gripping arms in the open position when not lifting an object, and a forklift folk safety chain to prevent the device from slipping off the forklift fork. The two receiving forklift fork receiving slots are designed to accommodate the forks of a fork lift which upon lifting of the fork, actuates the lifting and gripping arms to close around the base of the object to be lifted. The safety latch is actuated automatically by the user to initiate the gripping upon lifting. Once the lifted object is placed, the gripping arms are opened to release pressure on the object and simultaneously actuate the locking mechanism such that if the device is then lifted again, the gripping arms will not close unless and until the safety lock is manually released.

In the preferred embodiment of the present invention is comprised of three units: the lower lifting assembly (I), the upper assembly (II), and the forklift fork assembly (III), whereby the forklift fork assembly (III) is directly connected to the upper lift assembly (II), which is directly connected to the lower lift assembly (I) to form the complete lifting and gripping device. The lower lifting assembly (I) houses the lifting and gripping arms, lifting latch assembly, and the rubber friction bars. The upper assembly (II) is comprised of a force transfer unit, and striker ring. The forklift fork assembly (III) is comprised of the fork lift fork receiving tubes, pivot pin, beveled or wavy washer, and safety chain. The lower lifting assembly, upper assembly, and fork connection plate of the forklift fork assembly are comprised of strengthened non-tubular metal to prevent warping or buckling under load.

In another embodiment of the present invention, the right and left lower lift arms incorporating both longitudinally and latitudinally extendable and adjustable, pin locking legs and sleeves are provided and comprised of strengthened non-tubular metal to prevent warping or buckling under load. The extending, adjustable lift arm legs provide the capability of extension in both length and/or width allowing for the lifting of longer and/or wider objects.

In a further embodiment of the present invention, the rubber friction bars that grip the object to be moved and are located on the inside of the left and right lower lift arm grip bars, may be removed to accommodate various attachments, including but not limited to a raked teeth attachment. Said raked teeth attachment may be attached to the inside of the extendably adjustable right and left lower lift arms incorporating a pin locking mechanism for each leg and sleeve, whereby said raked teeth attachment extending from the bottom of each of the right and left lower lift arm grip bar(s) allow for enhanced lifting through the sides and the base of the lifted object.

By utilizing the current lifting and gripping device, a multitude of objects can be safety moved without excessive rotation around the forklift fork assembly by using the forks of a fork lift. Additional efficiencies may be gained through the use of the automatic lift latch locking mechanism to ensure the device will not open unexpectedly.

### BRIEF DESCRIPTION OF DRAWINGS

FIG. 1 is an example of the overall lifting and gripping device in the fully open position showing the three assemblies.

FIG. 2 shows various parts of the lower and upper lift assemblies.

FIG. 3 shows the right lower lift assembly and the lift latch assembly.

FIG. 4 shows the forklift fork assembly.

FIG. 5 is an example of the overall lifting and gripping device in the partially closed position showing the three assemblies.

### DETAILED DESCRIPTION OF THE INVENTION

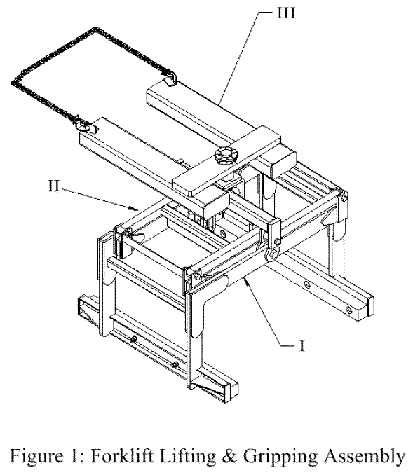

Referring now to the drawings, and more particularly FIG. 1, the present invention as shown in one embodiment is a view of the lifting and gripping device in the fully open position comprising the lower lift assembly (I), the upper lift assembly (II), and the forklift fork assembly (III).

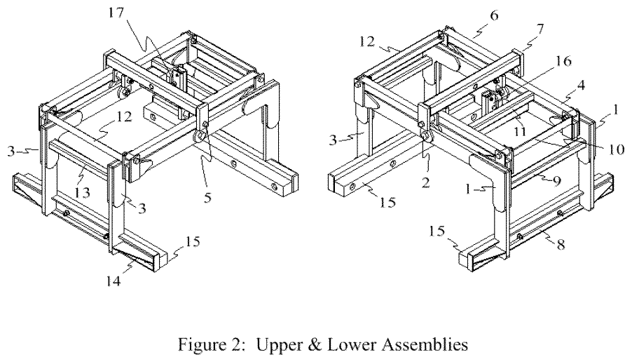

FIG. 2 shows a left and right side view of the fully open lower and upper lift assemblies (I, II); the right lower lift arm(s) (1), lower assembly rotational pivot pin (2), left lower lift arm(s) (3), right upper lift arm(s) (4), upper assembly rotational pivot pin (5), left upper lift arm(s) (6), upper assembly center lift link (7), right lower lift arm grip bar (8), right lower lift assembly stabilizing spacer (9), right upper lift assembly stabilizing spacer (10), upper assembly center stabilizing spacer (11), left upper lift assembly stabilizing spacer (12), left lower lift assembly stabilizing spacer (13), left lower lift arm grip bar (14), rubber friction bar (15), lift latch assembly (16), upper assembly striker ring (17), and their relative positions in the lifting device.

The lower lift assembly (I) is comprised of the right lower lift arm(s) (1), lower assembly rotational pivot pin (2), left lower lift arm(s) (3), right lower lift arm grip bar (8), right lower lift assembly stabilizing spacer (9), left lower lift assembly stabilizing spacer (13), left lower lift arm grip bar (14), and rubber friction bar (15) and are constructed from strengthen solid, non-tubular materials. The upper lift assembly (II) is comprised of the right upper lift arm(s) (4), upper assembly rotational pivot pin (5), left upper lift arm(s) (6), upper assembly center lift link (7), right upper lift assembly stabilizing spacer (10), upper assembly center stabilizing spacer (11), left upper lift assembly stabilizing spacer (12), upper assembly striker ring (17), and their relative positions in the lifting device. In the preferred embodiment, all components of the lower lift assembly (I), upper lift assembly (II), and forklift fork assembly (III), may be of any color, thickness, length, or shape and may be constructed, formed, machined, extruded, pressed, molded, cast, or otherwise made from any suitable material including but not limited to steel, stainless steel, or reinforced steel. The lower lift assembly (I) is comprised of a plurality of rotation points around which the lifting and grabbing device is actuated. In the present invention, said rotation pivot points are mechanical and without limitation hinged by a multitude of any suitable materials including but not limited to pins, bolts, rivets, or the like. Said rotation pivot points are preferably made from strengthened steel bolts.

In a second embodiment of the present invention, the right and left lower lift arms (1, 3) of the lower lift assembly (I), are extendable longitudinally through an outer sleeve (not shown) and pull pin means (not shown) thereby allowing wider objects to be grabbed and lifted. Further, the right and left lower lift arms (1, 3) of the lower lift assembly (I), are extendable latitudinally through an additional outer sleeve and pull pin means thereby allowing longer objects to be grabbed and lifted. This would allow both wider and longer objects to be lifted and moved by the device.

In a third embodiment of the present invention, the rubber friction bar (15) of the right and left lower lift arm grip bars (8, 14) of the lower lift assembly (I), is removable and replaced with a multitude of attachments including but not limited to a racked teeth attachment (not shown) to allow for enhanced lifting through the sides and the base of the lifted object.

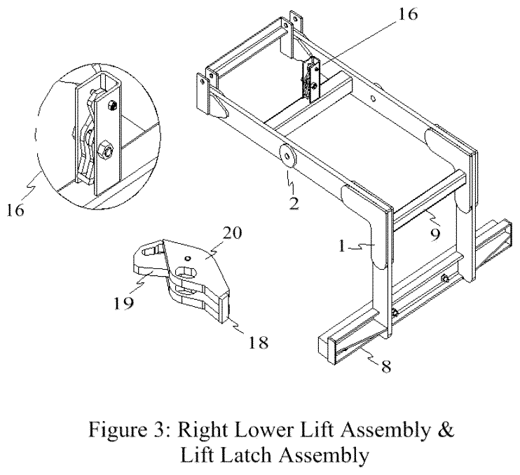

FIG. 3 shows an example of the right lower lift arm(s) (1), lower assembly rotational pivot pin point (2), right lower lift arm grip bar (8), right lower lift assembly stabilizing spacer (9), and the lift latch assembly (16). The lift latch assembly (16), is further comprised of the lift latch striker block (18), lift latch inside plate (19), and lift latch outside plate (20), whereby the lift latch assembly (16), engages with the upper assembly striker ring (17) of FIG. 2, when in the open position as follows:

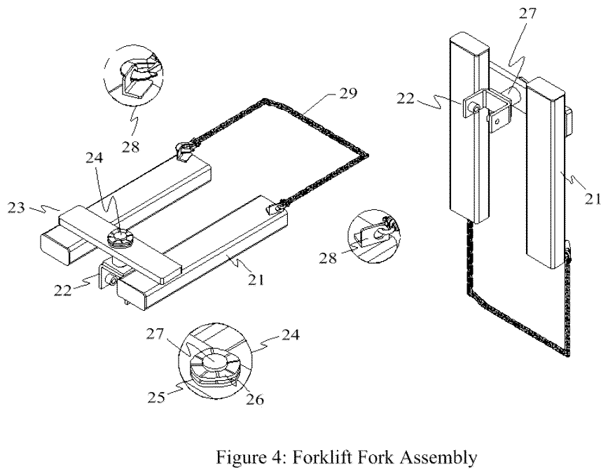

A fork lift operator would slide the forklift forks into the forklift fork lift tubes (21) of FIG. 4, and affix the safety chain; The forklift operator lifts the fork lift forks and the locked lifting and gripping device in the open position;

The forklift operator then positions the lifting and gripping device above the object to be lifted;

The operator then lowers the forklift forks into the proper position to safely grip the object such that the right and left lower lift arm grip bars (8, 14) are touching the ground at the base of the object to be moved;

Once grounded, the forklift operator applies a downward pressure on the forklift forks to cause the lift latch assembly (16), to release from the upper assembly striker ring (17);

The forklift operator then lifts the forklift forks to actuate the lifting and gripping device to close around the base of the object to be lifted; and

Once the lifting and gripping device has securely gripped the object, the forklift operator further lifts the forks of the forklift thereby lifting the object to be moved.

FIG. 4 shows the forklift fork assembly (III) comprised of the forklift fork lift tube (21), fork assembly bolster plate (22), fork assembly connection plate (23), fork assembly beveled or wavy washer assembly (24), fork assembly lower wavy washer (25), fork assembly upper wavy washer (26), fork assembly pivot pin (27), chain anchor angles (28), and the safety chain (29). The fork assembly lower and upper wavy washer(s) (25, 26), and fork assembly pivot pin (27), may be of any size, thickness, length, or shape and may be constructed, formed, machined, extruded, pressed, molded, cast, or otherwise made from any suitable material including but not limited to steel, stainless steel, or reinforced steel. Said fork assembly lower wavy washer (25) is affixed, preferably though a weld, to the fork assembly connection plate (23), and the fork assembly upper wavy washer (26) is affixed, preferably though a weld, to the fork assembly pivot pin (27), such that the welded fork assembly pivot pin (27), and upper wavy washer (26) pass through the center of the fork assembly lower wavy washer and fork assembly connection plate. This serves to retard rotation of the lifting and gripping assembly around the pivot pin (27) as the forklift moves the lifted object around. A safety chain (29) is affixed to chain anchor angles (28) which are preferably welded to the forklift fork lift tube(s) (21) to prevent the lifting and gripping device from sliding off the forks of the forklift while in operation.

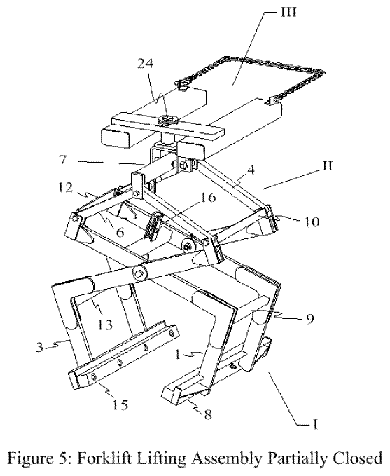

FIG. 5 shows a partially closed view of the forklift fork assembly (III), and the lower (I), and upper (II) lift assemblies; the right lower lift arm(s) (1), left lower lift arm(s) (3), right upper lift arm(s) (4), left upper lift arm(s) (6), upper assembly center lift link (7), right lower lift arm grip bar (8), right lower lift assembly stabilizing spacer (9), right upper lift assembly stabilizing spacer (10), left upper lift assembly stabilizing spacer (12), left lower lift assembly stabilizing spacer (13), rubber friction bar (15), lift latch assembly (16), and fork assembly wavy washer assembly (24), and their relative positions in the lifting and gripping device.

The various embodiments of the present invention as shown in FIGS. 1-5 may be arranged and designed in a wide variety of different configurations that fall within the scope of the present invention, and may be applied to any type of system involving the lifting and gripping of various materials to include but not limited to pavers, paver pallets, metal works, concrete blocks, CSU's, CMU's.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

The invention claimed is:

1. A lifting and gripping device assembly for the gripping, lifting, and movement of various objects comprising:
a lower lift assembly;
a lift latch assembly;
a rubber friction bar;
an upper lift assembly;
an upper assembly striker ring;
a forklift fork assembly;
a fork assembly wavy washer assembly;
a safety chain;
whereby the forklift fork assembly is directly attached to the upper lift assembly, and the upper lift assembly is directly attached to the lower lift assembly;
wherein the lower lift assembly, upper lift assembly, and forklift fork assembly are attached to each other through pins or bolts so as to allow for rotation, in whole or part, around the pins or bolts;
wherein the safety chain and fork assembly wavy washer assembly are directly attached to the forklift fork assembly, the lift latch assembly is attached to the lower lift assembly, and the upper assembly striker ring is attached to the upper lift assembly.

2. The apparatus of claim 1, wherein the lower lift, upper lift, and forklift fork assemblies are comprised of non-tubular reinforced materials capable of supporting heavy weight.

3. The apparatus of claim 1, wherein the lower lift, upper lift, and forklift fork assemblies may be of any color, thickness, length, or shape and may be constructed, formed, machined, extruded, pressed, molded, cast, or otherwise made from any suitable material including but not limited to steel, stainless steel, or reinforced steel.

4. The apparatus of claim 1, wherein the lower lift, upper lift, and forklift fork assemblies include a plurality of rotational pivot points around which the lifting and grabbing device is actuated, and wherein the rotational pivot points are mechanical and without limitation hinged by a multitude of any suitable materials including but not limited to pins, bolts, rivets, or the like.

5. A lifting and gripping device assembly for the gripping, lifting, and movement of various objects comprising:
a lower lift assembly;
a lift latch assembly;
a removable rubber friction bar;
an adjustably extendable pin locking leg and sleeve;
an upper lift assembly;
an upper assembly striker ring;
a forklift fork assembly;
a fork assembly wavy washer assembly;
a safety chain;
whereby the forklift fork assembly is directly attached to the upper lift assembly, and the upper lift assembly is directly attached to the lower lift assembly;
wherein the lower lift assembly, upper lift assembly, and forklift fork assembly are attached to each other through pins or bolts so as to allow for rotation, in whole or part, around the pins or bolts;
wherein the safety chain and fork assembly wavy washer assembly are directly attached to the forklift fork assembly, the lift latch assembly is attached to the lower lift assembly, and the upper assembly striker ring is attached to the upper lift assembly;
wherein the adjustably extendable pin locking leg and sleeve is a modification of the right and left lower lift arms of the lower lift assembly such that the right and left lower lift arms are extendable both longitudinally and latitudinally.

6. The apparatus of claim 5, wherein the lower lift, upper lift, and forklift fork assemblies are comprised of non-tubular reinforced materials capable of supporting heavy weight.

7. The apparatus of claim 5, wherein the lower lift, upper lift, and forklift fork assemblies may be of any color, thickness, length, or shape and may be constructed, formed, machined, extruded, pressed, molded, cast, or otherwise made from any suitable material including but not limited to steel, stainless steel, or reinforced steel.

8. The apparatus of claim 5, wherein the lower lift, upper lift, and forklift fork assemblies include a plurality of rotational pivot points around which the lifting and grabbing device is actuated, and wherein the rotational pivot points are mechanical and without limitation hinged by a multitude of any suitable materials including but not limited to pins, bolts, rivets, or the like.

9. The apparatus of claim 5, wherein the adjustably extendable pin locking leg and sleeve modification of the right and left lower lift arms of the lower lift assembly may be of any color, thickness, length, or shape and may be constructed, formed, machined, extruded, pressed, molded, cast, or otherwise made from any suitable material including but not limited to strengthened non-tubular steel, stainless steel, or reinforced steel.

10. A lifting and gripping device assembly for the gripping, lifting, and movement of various objects comprising:
a lower lift assembly;
a lift latch assembly;
a removable rubber friction bar;
a raked teeth attachment;
an adjustably extendable pin locking leg and sleeve;
an upper lift assembly;
an upper assembly striker ring;
a forklift fork assembly;
a fork assembly wavy washer assembly;
a safety chain;
whereby the forklift fork assembly is directly attached to the upper lift assembly, and the upper lift assembly is directly attached to the lower lift assembly and are comprised of non-tubular reinforced materials and may be of any color, thickness, length, or shape and may be constructed, formed, machined, extruded, pressed, molded, cast, or otherwise made from any suitable material including but not limited to steel, stainless steel, or reinforced steel capable of supporting heavy weight;
wherein the lower lift assembly, upper lift assembly, and forklift fork assembly are attached to each other through, and include a plurality of rotational pivot points around which the lifting and grabbing device is actuated, and wherein the rotational pivot points are mechanical and without limitation hinged by a multitude of any suitable materials including but not limited to pins, bolts, rivets, or the like;
wherein the adjustably extendable pin locking leg and sleeve is a modification of the right and left lower lift arms of the lower lift assembly such that the right and left lower lift arms are extendable both longitudinally and latitudinally and may be of any color, thickness, length, or shape and may be constructed, formed, machined, extruded, pressed, molded, cast, or otherwise made from any suitable material including but not limited to strengthened non-tubular steel, stainless steel, or reinforced steel;
wherein the safety chain and fork assembly wavy washer assembly are directly attached to the forklift fork assembly, the lift latch assembly is attached to the lower lift assembly, and the upper assembly striker ring is attached to the upper lift assembly;
wherein the removable rubber friction bar of the right and left lower lift arm grip bars of the lower lift assembly, are replaced with a multitude of attachments including but not limited to a racked teeth attachment to allow for enhanced lifting through the sides and the base of the lifted object.
